(19) United States
(12) Patent Application Publication
(10) Pub. No.: US 2023/0339551 A1
(43) Pub. Date: Oct. 26, 2023

(54) SIDE-HINGED TRUCK BED COVERS

(71) Applicant: Diamondback Automotive Accessories, Inc., Philipsburg, PA (US)

(72) Inventors: Daniel J. Gongloff, Ashville, PA (US); Michael K. Pfeiffer, Conifer, CO (US); Brandon Jacob Moist, Hummelstown, PA (US); Cody Thompson Byron, Philipsburg, PA (US); Travis Paul Dodson, Hollidaysburg, PA (US)

(21) Appl. No.: 18/138,054

(22) Filed: Apr. 22, 2023

Related U.S. Application Data
(60) Provisional application No. 63/333,997, filed on Apr. 22, 2022.

(51) Int. Cl. B62D 33/04; B60J 7/16

(52) U.S. Cl. CPC B62D 33/04; B60J 7/1621

(57) ABSTRACT

Side-hinged truck bed covers that are pivoted or hinged at or near a top edge of one of the truck bed side walls are disclosed. A side hinge pivotally connects a side edge of the bed cover to one of the truck bed side walls, and an opposite side edge of the bed cover is opened by lifting the cover from the other truck bed sidewall.

### CROSS-REFERENCE TO RELATED APPLICATION

This application claims the benefit of U.S. Provisional Patent Application No. 63/333,997 filed Apr. 22, 2022, which is incorporated herein by reference.

### FIELD OF THE INVENTION

The present invention is directed to side-hinged truck bed covers.

### BACKGROUND INFORMATION

Various types of pickup truck bed covers are known. However, a need exists for truck bed covers that are easy to use and possess desirable structural and functional features.

### SUMMARY OF THE INVENTION

The present invention provides side-hinged truck bed covers that are pivoted or hinged at or near a top edge of one of the truck bed side walls. A side hinge pivotally connects a side edge of the bed cover to one of the truck bed side walls, and an opposite side edge of the bed cover is opened by lifting the cover from the other truck bed sidewall.

An aspect of the present invention is to provide a side-hinged truck bed cover comprising a cover panel structured and arranged to selectively cover a truck bed and comprising a first side edge and an opposing second side edge, and a side hinge located adjacent the first side edge of the cover panel structured and arranged for mounting adjacent a sidewall of the truck bed, wherein the second side edge of the cover panel is movable from a closed position adjacent an opposite sidewall of the truck bed to an open position allowing access to an interior region of the truck bed.

Another aspect of the present invention is to provide a truck bed and side-hinged truck bed cover assembly comprising a truck bed comprising a left sidewall, a right sidewall, a front wall and a bed floor, and a side-hinged truck bed cover. The side-hinged truck bed cover comprises a cover panel comprising a first side edge and an opposing second side edge, and a side hinge located adjacent the first side edge of the cover panel and mounted adjacent one of the right sidewall or the left sidewall of the truck bed, wherein the second side edge of the cover panel is movable from a closed position adjacent the other one of the right sidewall or the left sidewall of the truck bed to an open position allowing access to an interior region of the truck bed.

These and other aspects of the present invention will be more apparent from the following description.

### BRIEF DESCRIPTION OF THE DRAWINGS

FIG. 1 is a partially schematic isometric view of a pickup truck bed with a side-hinged truck bed cover installed thereon.

FIG. 2 is a partially schematic isometric view of the side-hinged truck bed and cover of FIG. 1 with the cover in an open position and with the tailgate of the pickup truck bed in an open position.

FIG. 3 is a partially schematic isometric view similar to FIG. 2 with equipment stored on top of the cover and on the underside of the cover.

FIG. 4 is another partially schematic isometric view of a side-hinged truck bed cover in an open position and with the tailgate in an open position.

FIG. 5 is a partially schematic side view of a portion of a side-hinged truck bed cover pivotally mounted on a sidewall of a pickup truck bed.

FIG. 6 is a partially schematic rear view of a side-hinged truck bed cover in a closed position with a tailgate of the pickup truck bed in an open position.

FIG. 7 is an isometric view of a truck bed cover panel fabricated from a front cover panel portion and a rear cover panel portion that are joined together at a seam.

FIG. 8 is a top view of the cover panel of FIG. 7.

FIG. 9 is a side view of the cover panel of FIG. 7.

FIG. 10 is a bottom view of the cover panel of FIG. 7.

FIG. 11 is a bottom view of the front cover panel portion of FIG. 7.

FIG. 12 is a bottom view of the rear cover panel portion of FIG. 7.

### DETAILED DESCRIPTION

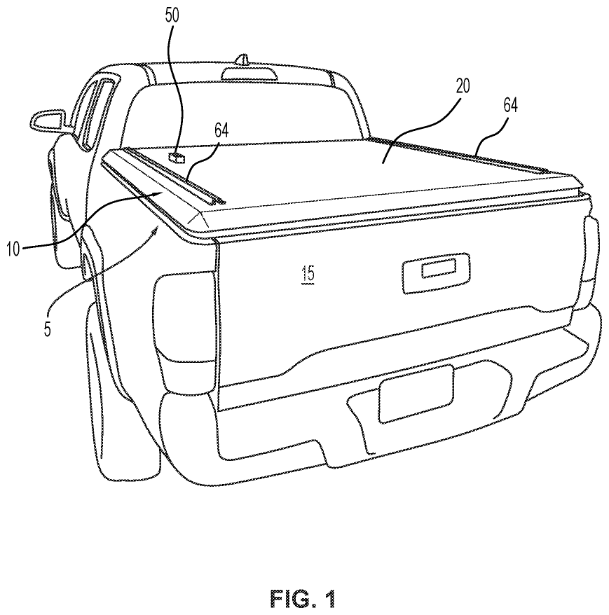

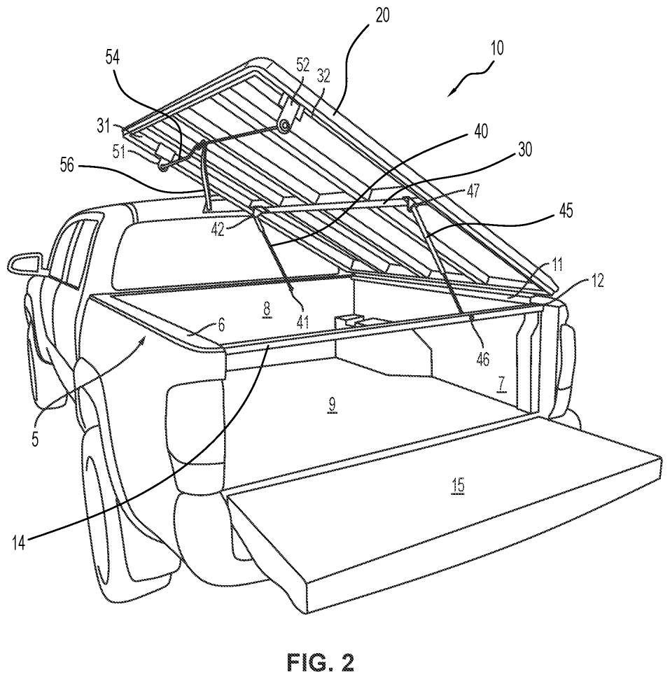

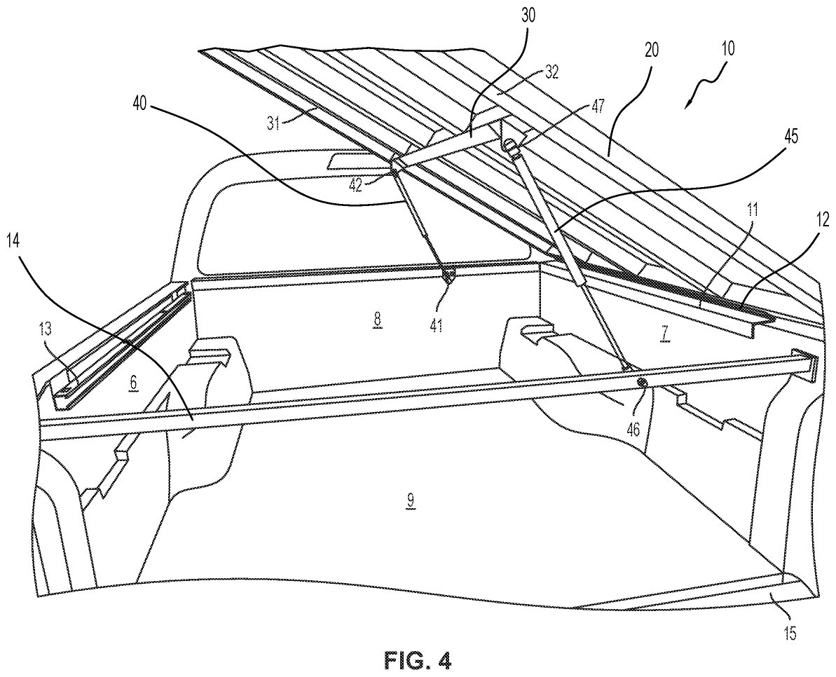

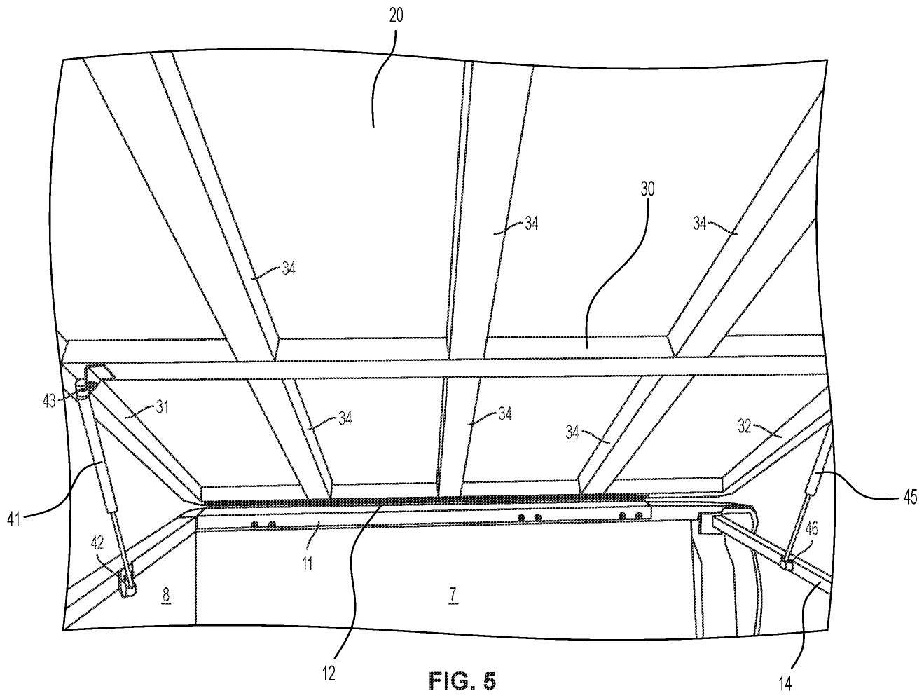

As shown in FIGS. 1-6, a pickup truck bed 5 has a side-hinged truck bed cover 10 mounted thereon. The side-hinged truck bed cover 10 includes a cover panel 20 that is shown in a closed position in FIGS. 1 and 6, and is shown in an open position in FIGS. 2-5. As shown most clearly in FIG. 2, the pickup truck bed 5 includes a left sidewall 6, a right sidewall 7, and a front wall 8. The pickup truck bed 5 includes a bed floor 9 and a folding tailgate 15. A hinge bracket 11 is secured on or near a top edge of the right sidewall 7. The hinge bracket 11 includes a side hinge 12 that is used to pivotally mount the cover panel 20 on the upper edge of the right sidewall 7. The side hinge 12 may comprise a piano hinge, as shown in the figures. However, any suitable hinge or pivoting mechanism may be used as the side hinge, for example, more than one piano hinge, one or more door-type hinges, offset clearance hinges such as automotive trunk hinges, multi-bar hinges such as automotive hood hinges, and the like. An optional receiving bracket 13 may be secured on or near a top edge of the left sidewall 6 for engagement with a left edge of the cover panel 20. Although the side hinge 12 is shown on the right sidewall 7 in the figures, the hinge may alternatively be provided on the left sidewall 6.

A rear cross brace 14 extends between the left and right sidewalls 6 and 7 at upper rear corners thereof. As shown in FIGS. 2, 4 and 6, the rear cross brace 14 remains in position when the tailgate 15 is in its lowered position. The rear cross brace 14 may run across the back of the truck bed and may be mounted on or adjacent to the upper side edges of the truck bed side walls 6 and 7. As more fully described below, the rear cross brace 14 may provide a mounting support for a rear support strut 45 and may provide strengthening of the truck bed sidewalls 6 and 7, particularly when the tailgate 15 is lowered and/or when the cover panel 20 is raised. Although a straight rear cross brace 14 with a square cross-section is shown in the figures, any other suitable shape or configuration may be used. Furthermore, the rear brace may be positioned in different locations, such as extending from various locations in proximity to the rear portions of the truck bed sidewall(s) 6 and 7 and/or the bed floor 9.

As more fully described below, the cover panel 20 may optionally be provided in the form of a front cover panel portion 21 and a rear cover panel portion 22 that are attached together by any suitable means such as welding, mechanical fasteners or the like at a cross seam 24. The cover panel 20 may optionally be partially or totally coated with one or more coatings, sheets, claddings, and the like. For example, the exposed top surface and side edge surfaces of the cover panel 20 may be coated with durable paint and/or covered with at least one layer of protective material such as truck bed liner materials and coatings, for example, a polyurethane cross-linking coating with a UV resistant top coating.

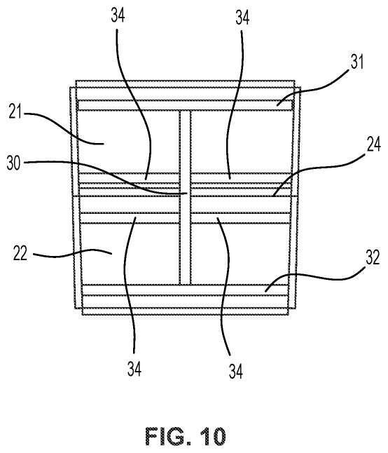

As shown most clearly in FIGS. 2, 4, 5 and 10, the cover panel 20 includes a longitudinal stud or backbone 30 extending centrally on the underside along the length of the cover panel 20. A front cross stud 31 is provided on the underside of the front of the cover panel 20 at a front end of the backbone 30, and a rear cross stud 32 is provided on the underside of the rear of the cover panel 20 at a rear end of the backbone 30. Multiple mid studs 34 may be provided as needed between the front and rear cross studs 31 and 32 extending transversely from the central longitudinal backbone 30. As shown, the cover panel 20 may be supported underneath by the longitudinal backbone 30 stud, the front cross stud 31, the rear cross stud 32, and multiple mid-studs 34. Welding or any other attachment means such as mechanical fasteners or adhesives at selected connection points may be used. While a particular number and configuration of support studs are shown, any other suitable number, configuration, sizes, etc. of support components may be used.

As shown most clearly in FIGS. 2-5, a front support strut 40 is provided near the front of the cover panel 20. A front wall pivot connection 41 connects one end of the front support strut 40 to the front wall 8 of the truck bed 5. A front cover pivot connection 42 connects the opposite end of the front support strut 40 to the backbone 30 at the front of the cover panel 20. A rear support strut 45 is provided near the rear of the cover panel 20. A rear cross brace pivot connection 46 connects one end of the rear support strut 45 to the rear cross brace 14, and a rear cover pivot connection 47 connects the opposite end of the rear support strut 45 to the backbone 30 at the rear of the cover panel 20. As shown, the front support strut 40 and rear support strut 45 may each be secured at their upper ends to the front and rear ends of the central backbone 30 stud, and may be secured at their other ends to the top of the front wall of the truck bed 8 and the rear cross brace 14, respectively. However, any other suitable attachment means, and any other suitable number and positions of attachment means may be used. The front and rear support struts 40 and 45 may be of any suitable design, such as conventional pneumatic piston struts. Alternatively, the front and rear support struts 40 and 45 may be provided in the form of compound hinges such as offset clearance hinges and/or multi-bar hinges that may be spring or pneumatically loaded to help raise the cover panel 20 when it is opened. In such embodiments, the compound hinges may act as the side hinge, e.g., without the need for a separate piano hinge, door-type hinges, etc.

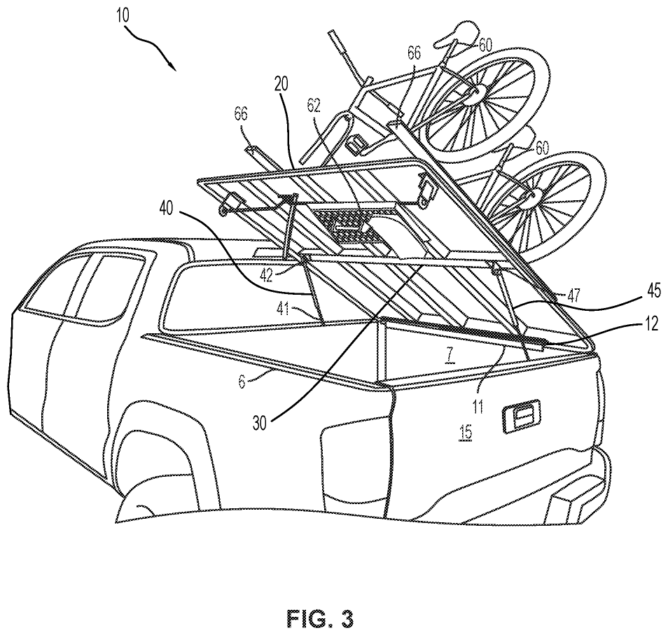

As shown in FIG. 1, a handle 50 may be provided on a top surface of the cover panel 20. Any suitable number and locations of handle(s) may be provided. As shown in FIG. 2, a front lock bracket 51 may be provided near the front of the cover panel 20, and a rear lock bracket 52 may be provided at the rear of the cover panel 20. As schematically shown in FIGS. 2 and 3, a lock rod 54 assembly may extend between the front and rear lock brackets 51 and 52. A hand tether 56 may be connected to the lock rod 54 assembly in order to facilitate closing of the cover panel 20 from the open position shown in FIG. 2 to a closed position shown in FIG. 1. In the embodiment shown, the lock rod assembly 54 is provided near the left opening edge of the cover panel 20 and extends in a longitudinal direction between the front truck bed wall 8 and the rear cross brace 14. The lock rod assembly 54 may be extended to lock the cover panel 20 when the cover panel is closed, and may be retracted to unlock the cover panel 20 in order to open the cover panel 20. The handle 50 may be engaged with the lock rod assembly 54, and any suitable type of standard linkage may be used to extend and retract the front and rear rod portions of the lock rod assembly 54, such as a rotary linkage known to those skilled in the art. The handle 50 and/or lock rod assembly 54 may include any suitable type of standard locking mechanism for securing the cover panel 20 in its closed position.

As shown in FIG. 3, the truck bed cover 10 may provide for upper storage 60 on top of the cover panel 20, and lower storage 62 under the cover panel 20, in order to store and transport various articles such as bikes, kayaks, recreational equipment, tools, tents, ATVs, UTVs, motorcycles, and the like. Any suitable types of mounting brackets or holders may be installed on the cover panel 20 as desired. As shown in FIG. 1, longitudinally extending support rails 64 may be provided on the cover panel 20. Such support rails 64 may be of any suitable configuration, such as conventional automotive roof rails to which OEM or after-market components may be secured, such as roof racks, carriers and platforms. As shown in FIG. 3, roof racks in the form of cross bars 66 may be fastened to the top of the cover panel 20, for example, by mounting the cross bars 66 to the support rails 64 shown in FIG. 1. In this manner, the side-hinged truck bed cover 10 can be used to carry various types of articles and equipment using conventional roof rack systems.

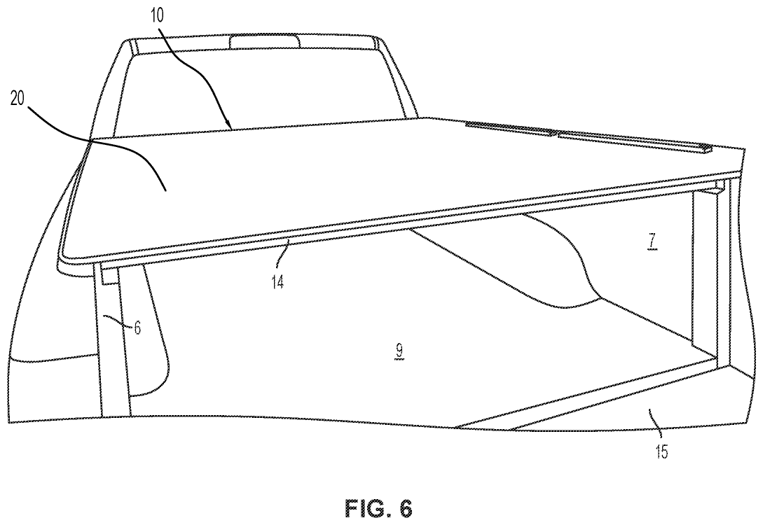

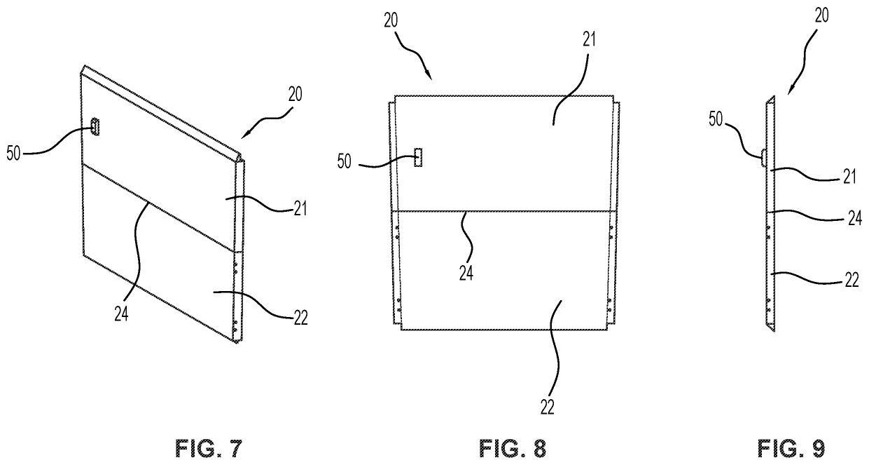

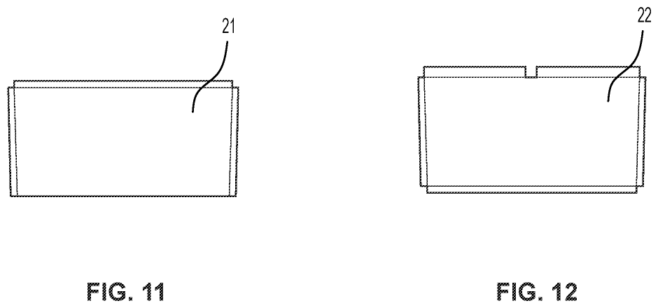

FIGS. 7-12 illustrate that the cover panel 20 may optionally be fabricated from two or more panels, such as a front cover panel portion 21 and rear cover panel portion 22, which may be welded together or otherwise joined or connected by mechanical fasteners, or the like. In the embodiment shown, a cross seam 24 connects the front and rear cover panel portions 21 and 22 together. The cross seam may be welded, mechanically fastened, etc. The cover panel 20 may include a front cover panel portion 21, a rear cover panel portion 22, and a cross seam 24 connecting the front and rear cover panel portions 21 and 22. Although two cover panel portions are shown, any suitable number of cover panel portions may be used, for example, one, three, or more cover panels.

The components of the side-hinged truck bed covers may be made from any suitable materials including metals such as steel and aluminum. As described above, coatings may be applied to the components, for example, at least the top of the bed cover may be coated with durable wear-resistant materials such as truck bed liner materials and coatings, for example, a polyurethane cross-linking coating with a UV resistant top coating.

As used herein, “including,” “containing” and like terms are understood in the context of this application to be synonymous with “comprising” and are therefore open-ended and do not exclude the presence of additional undescribed or unrecited elements, materials, phases or method steps. As used herein, “consisting of” is understood in the context of this application to exclude the presence of any unspecified element, material, phase or method step. As used herein, “consisting essentially of” is understood in the context of this application to include the specified elements, materials, phases, or method steps, where applicable, and to also include any unspecified elements, materials, phases, or method steps that do not materially affect the basic or novel characteristics of the invention.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. In this application and the appended claims, the articles “a,” “an,” and “the” include plural referents unless expressly and unequivocally limited to one referent.

Whereas particular embodiments of this invention have been described above for purposes of illustration, it will be evident to those skilled in the art that numerous variations of the details of the present invention may be made without departing from the invention.

1. A side-hinged truck bed cover comprising:
a cover panel structured and arranged to selectively cover a truck bed and comprising a first side edge and an opposing second side edge; and
a side hinge located adjacent the first side edge of the cover panel structured and arranged for mounting adjacent a sidewall of the truck bed, wherein the second side edge of the cover panel is movable from a closed position adjacent an opposite sidewall of the truck bed to an open position allowing access to an interior region of the truck bed.

2. The side-hinged truck bed cover of claim 1, wherein the side hinge is mounted on an upper edge of the sidewall.

3. The side-hinged truck bed cover of claim 2, wherein the side hinge comprises a hinge bracket fastened to the upper edge of the sidewall.

4. The side-hinged truck bed cover of claim 1, wherein the side hinge comprises a piano hinge.

5. The side-hinged truck bed cover of claim 1, further comprising a front support strut connected at one end thereof adjacent a front edge of the cover panel, wherein another end of the front support strut is structured and arranged for mounting on a front wall of the truck bed.

6. The side-hinged truck bed cover of claim 1, further comprising a rear support strut connected at one end thereof adjacent a rear edge of the cover panel.

7. The side-hinged truck bed cover of claim 6, further comprising a rear cross brace structured and arranged for mounting adjacent a rear portion of the truck bed, wherein another end of the rear support strut is connected to the rear cross brace.

8. The side-hinged truck bed cover of claim 7, wherein the cross brace is structured and arranged for mounting on an upper rear end of the left sidewall of the truck bed and on an upper rear end of the right sidewall of the truck bed.

9. The side-hinged truck bed cover of claim 1, further comprising a lock rod assembly adjacent the second side edge of the cover panel structured and arranged to releasingly engage the truck bed to thereby lock the cover panel in the closed position.

10. The side-hinged truck bed cover of claim 1, further comprising at least one support rail on a top surface of the cover panel structured and arranged to secure at least one roof rack cross bar thereto.

11. A truck bed and side-hinged truck bed cover assembly comprising:
a truck bed comprising a left sidewall, a right sidewall, a front wall and a bed floor; and
a side-hinged truck bed cover comprising:
a cover panel comprising a first side edge and an opposing second side edge; and
a side hinge located adjacent the first side edge of the cover panel and mounted adjacent one of the right sidewall or the left sidewall of the truck bed, wherein the second side edge of the cover panel is movable from a closed position adjacent the other one of the right sidewall or the left sidewall of the truck bed to an open position allowing access to an interior region of the truck bed.

12. The assembly of claim 11, wherein the side hinge is mounted on an upper edge of the right sidewall or the left sidewall.

13. The assembly of claim 12, wherein the side hinge comprises a hinge bracket fastened to the upper edge of the right sidewall or the left sidewall.

14. The assembly of claim 11, wherein the side hinge comprises a piano hinge.

15. The assembly of claim 11, further comprising a front support strut connected at one end thereof adjacent a front edge of the cover panel, wherein another end of the front support strut is structured and arranged for mounting on a front wall of the truck bed.

16. The assembly of claim 11, further comprising a rear support strut connected at one end thereof adjacent to a rear edge of the cover panel.

17. The assembly of claim 16, further comprising a rear cross brace mounted adjacent a rear portion of the truck bed, wherein another end of the rear support strut is connected to the rear cross brace.

18. The assembly of claim 17, wherein the cross brace is mounted on an upper rear end of the left sidewall of the truck bed and on an upper rear end of the right sidewall of the truck bed.

19. The assembly of claim 11, further comprising a lock rod assembly adjacent the second side edge of the cover panel structured and arranged to releasingly engage the truck bed to thereby lock the cover panel in the closed position.

20. The assembly of claim 11, further comprising at least one support rail on a top surface of the cover panel structured and arranged to secure at least one roof rack cross bar thereto.
